(19) United States
(12) Patent Application Publication
(10) Pub. No.: US 2024/0278506 A1
(43) Pub. Date: Aug. 22, 2024

(54) METHOD AND PLANT FOR MANUFACTURING THREE-DIMENSIONAL ARTICLES BY DEPOSITION OF A PLURALITY OF OVERLAPPING LAYERS OF A MATERIAL FOR ADDITIVE MANUFACTURING

(71) Applicant: BRETON S.P .A., Castello di Godego (TV) (IT)

(72) Inventors: Luca TONCELLI, Bassano del Grappa (VI) (IT); Claudio SAURIN, Rubano (PD) (IT); Gabriele CORLETTO, Cittadella (PD) (IT); Massimiliano MORUZZI, Rockford, IL (US); Francesco IORIO, Toronto (CA)

(21) Appl. No.: 18/561,069

(22) PCT Filed: May 20, 2022
(86) PCT No.: PCT/IB2022/054733

§ 371 Date: Nov. 15, 2023

(30) Foreign Application Priority Data
May 21, 2021 (IT) 102021000013289

(51) Int. Cl. B29C 64/393; B29C 64/209; B29C 64/321; B33Y 10/00; B33Y 30/00; B33Y 50/02

(52) U.S. Cl. CPC B29C 64/393; B29C 64/209; B29C 64/321; B33Y 10/00; B33Y 30/00; B33Y 50/02

(57) ABSTRACT

A method for manufacturing three-dimensional articles by means of deposition of a plurality of overlapping or adjoining layers of a material for additive manufacturing, comprising a step i) of manufacturing test samples, a step ii) of detecting and collecting data regarding process parameters relating to the deposition of the material and/or data regarding geometric and/or dimensional and/or qualitative and/or structural characteristics of the layers of material, a step iii) of processing the data detected during step ii) in order to obtain optimized reference values of the process parameters and a step iv) of manufacturing the article based on the optimized reference values of the process parameters obtained for the test samples. The data processing step iii) is performed by means of a process for training software based on at least one artificial intelligence algorithm. The disclosure also relates to a plant (1) for manufacturing three-dimensional articles by deposition of a plurality of overlapping or adjoining layers of a material for additive manufacturing.

The present invention relates to a method for manufacturing three-dimensional articles by deposition of a plurality of overlapping or adjoining layers of a material for additive manufacturing.

The invention also relates to a plant for manufacturing three-dimensional articles by deposition of a plurality of overlapping or adjoining layers of a material for additive manufacturing.

In the continuation of the present description the expression “overlapping or adjoining layers” is understood as meaning layers of material for additive manufacturing which are superimposed partly or totally or are arranged alongside each other with respective surfaces at least partially making contact.

Plants and industrial machines for manufacturing three-dimensional articles by deposition of a plurality of overlapping or adjoining layers of a material for additive manufacturing, for example a thermoplastic material, have been known for some time.

These plants and machines are preferably of the computerized numerical control type with Cartesian or anthropomorphic movements and may also have large dimensions, depending on the type of three-dimensional articles to be manufactured.

Generally the thermoplastic material used in the process for manufacturing three-dimensional articles is chosen from the group comprising acrylonitrile butadiene styrene (ABS), as such or reinforced with carbon fibre or glass fibre, nylon, as such or reinforced with carbon fibre or glass fibre, polycarbonates which may be reinforced with carbon fibre or glass fibre, polyether ether ketone (PEEK), polypropylene (PP) and polylactic acid (PLA).

In a manner known per se, said thermoplastic material is designed to be heated, melted, extruded and deposited in overlapping or adjoining layers on a support table, using a technology known as fused deposition modelling.

For this purpose, the machines for depositing the layers of thermoplastic material, also called 3D printing machines, comprise an extruder device, the extruder device comprising in turn at least one extruder element, a pump designed to ensure a homogeneous and constant flow of thermoplastic material and a nozzle.

The extruder element, if present, is preferably a screw extruder and has the function of melting the thermoplastic material by means of heating and feeding the melted material to the pump; in the absence of the extruder element the melted material is fed directly to the nozzle; the pump is preferably a gear pump and has the function of ensuring that the flow of melted thermoplastic material with which the nozzle is fed is constant.

The material for additive manufacturing may also be different from thermoplastic material and be chosen from the group which comprises composite materials, ceramic materials, metals and concrete.

In this connection the extruder device must be suitably modified with respect to the known extruder devices for the deposition of layers of thermoplastic material.

The extruder device is mounted on suitable movement structures or movement means designed to allow the movement thereof inside the working area.

The movement structures may comprise, for example, an anthropomorphic robot, at the ends of which the extruder device is mounted.

Alternatively, the movement structures may also be of the Cartesian type and may comprise a beam slidably mounted on a pair of side shoulders and comprising a first carriage slidably mounted on the said beam.

In turn the extruder device may also be slidable with respect to the first carriage along a direction perpendicular to a table supporting the three-dimensional articles.

One drawback of the plants and the machines described above consists in the difficulty of controlling and adjusting the operating conditions and the parameters for deposition of the layers of material for additive manufacturing in real time during the manufacture of the three-dimensional articles.

This drawback may result in the formation of imperfections in the deposited layers of material for additive manufacturing, mainly in the thermoplastic material, such as geometric and/or dimensional variations, delamination, deformation and porosity and/or a reduction in the mechanical strength of the three-dimensional article.

In order to overcome at least partially this drawback plants and machines for manufacturing three-dimensional articles which comprise a closed-loop feedback control system for deposition of the layers of material have been developed.

In particular, these plants and machines may comprise one or more sensors associated with the extruder device and/or the structures for movement thereof.

The sensors are configured to detect a series of predetermined data regarding process parameters relating to the deposition of the material, for example the pressure and the temperature of the thermoplastic material output from the nozzle, the speed of displacement or translation of the extruder device and/or the dimensions of the layers of thermoplastic material deposited on the support table.

Moreover, the sensors transmit the detected data to the control unit or controller which allows the almost instantaneous adjustment of the operating conditions of the extruder device, such as the speed of rotation of the pump and the speed of rotation of the screw of the extruder element or the relative speed of movement of the extruder device on the basis of the detected data.

Examples of plants and machines of the type indicated above are described in the patents and in the U.S. Pat. No. 10,377,124, U.S. Ser. No. 10,688,719 and US2020/0276757.

For example, U.S. Pat. No. 10,377,124 describes a machine of the type indicated above in which the speed of rotation of the extruder and the speed of rotation of the pump are adjusted depending on an increase or a decrease in the speed of displacement of the extruder device or depending on an increase or a decrease in the speed of deposition of the thermoplastic material.

U.S. Pat. No. 10,688,719 describes a machine of the type indicated above in which a controller adjusts the speed of rotation of the pump with respect to the speed of displacement of the extruder device and the pressure of the thermoplastic material output from the nozzle.

The controller is furthermore configured to control the relative ratio of the speed of displacement of the extruder device and the speed of rotation of the pump so as to adjust the flow of thermoplastic material and consequently the size of the layers of the thermoplastic material which are deposited.

These solutions are not without certain drawbacks.

A first drawback consists in the fact that the closed-loop feedback control system operates with a certain delay in relation to the deposition of the layers of thermoplastic material.

This drawback is particularly significant in the case of large-size plants with extruder devices having particularly high capacities for extrusion and deposition of the thermoplastic material. Moreover, this drawback is particularly evident in the case where the speed of displacement of the extruder device must be kept at particularly high values or in the case where the portions of the three-dimensional article to be manufactured have small radii of curvature. Therefore, these plants and machines are unable to avoid completely the formation of imperfections or zones with low mechanical strength in some portions of the three-dimensional article.

Furthermore, the plants and the machines described above may be subject to further problems and drawbacks such as:
lower material deposition speeds;
greater amount of waste material during the material deposition process;
increased costs;
smaller range of three-dimensional articles which can be manufactured, in particular articles with large dimensions or comprising portions with complex geometric forms.

The main object of the present invention is to provide a method and a plant for manufacturing three-dimensional articles by means of deposition of a plurality of overlapping or adjoining layers of a material for additive manufacturing, which are able to solve the drawbacks indicated above.

A particular task of the present invention is to provide a method and a plant of the type described above able to predict and therefore prevent the formation of imperfections and defects in the deposited layers and in the three-dimensional articles to be manufactured so as to adjust consequently a series of process parameters relating to the deposition of the layers of material in order to avoid the formation of the defects and/or the imperfections.

A further task of the present invention is to provide a method and a plant of the type described above which are able to avoid the formation in the articles of specific imperfections such as delamination, geometric or dimensional variations, deformations, thermal distortions, porosities or zones with low mechanical strength.

Another task of the present invention is to provide a method and a plant of the type described above which allow the manufacture of three-dimensional articles with portions having complex forms or geometries without negative effects for the structural characteristics.

A further task of the present invention is to provide a method and a plant of the type described above which allow the manufacture of three-dimensional articles having particularly high deposition speeds so as to increase the production capacity of the plant.

A further task of the present invention is to provide a method and a plant of the type described above which allow a reduction in the amount of waste material during the process for manufacturing three-dimensional articles.

The object and the main task described above are achieved with a method for manufacturing three-dimensional articles according to claim 1 and with a plant for manufacturing three-dimensional articles according to claim 19.

In order to illustrate more clearly the innovative principles of the present invention and its advantages compared to the prior art, an example of embodiment of a plant for manufacturing three-dimensional articles according to the present invention will be described below with the aid of the attached figures. In particular:

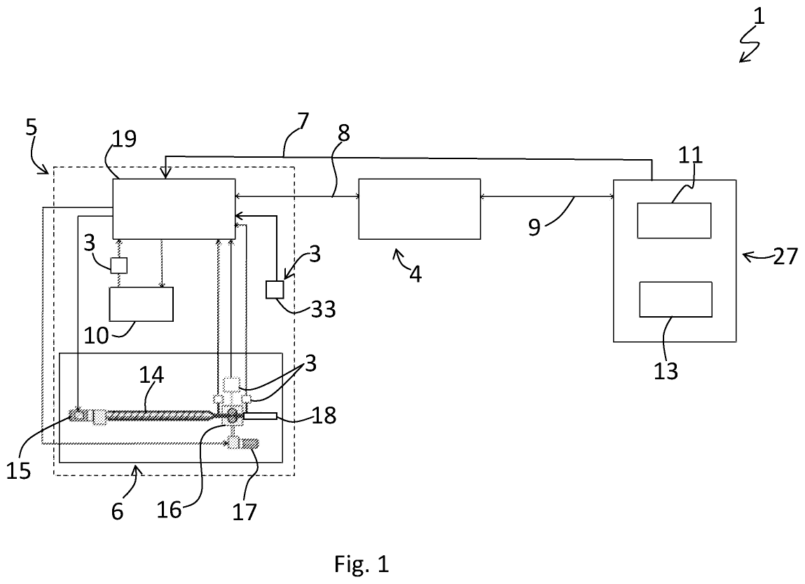

FIG. 1 is a schematic block diagram of the plant for manufacturing three-dimensional articles according to the present invention;

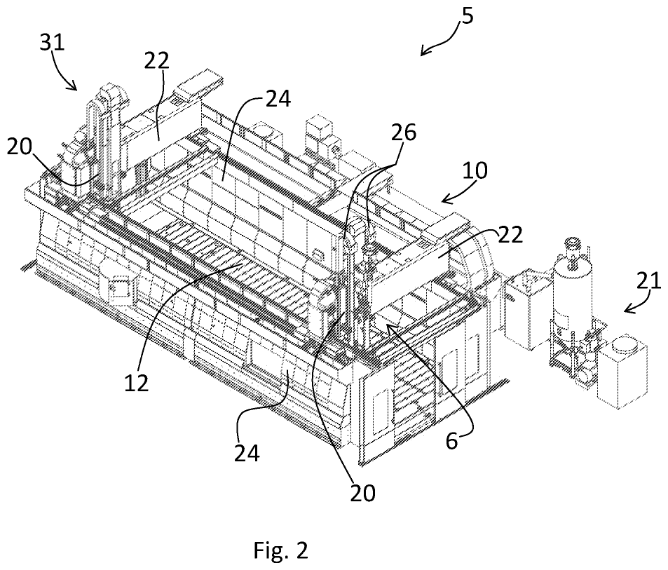

FIG. 2 is a perspective view of a numerical control machine of the plant according to the present invention;

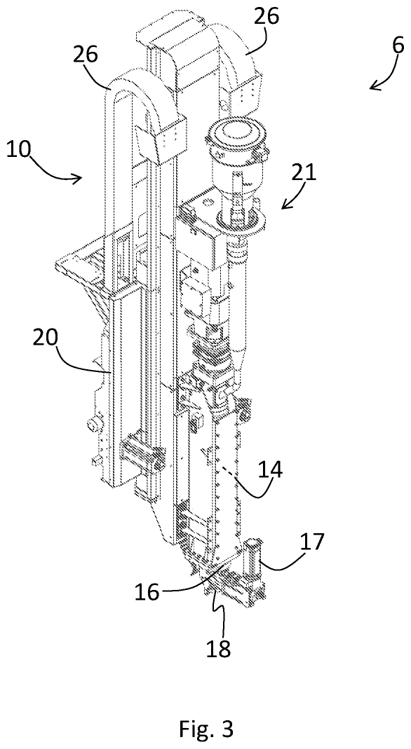

FIG. 3 is a perspective view of the extruder device of the numerical control machine shown in FIG. 2;

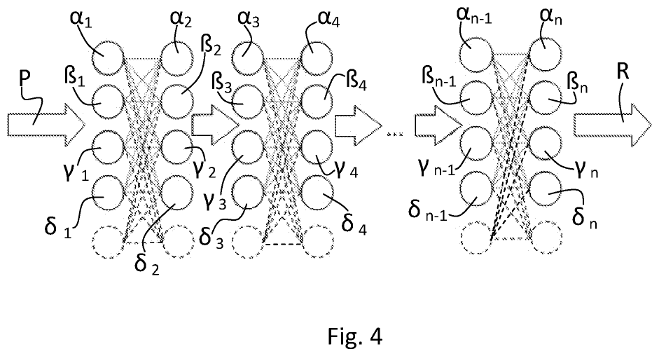

FIG. 4 shows in schematic form a deep neural network model used in the present invention.

The present description, provided solely by way of illustration and not limiting the scope of protection of the invention, relates to a method and a plant for manufacturing three-dimensional articles by means of deposition of a plurality of overlapping or adjoining layers of a material for additive manufacturing.

With particular reference to FIG. 1 the plant for manufacturing three-dimensional articles is indicated overall by the reference number 1.

In the continuation of the present description reference will be made mainly by way of example to a thermoplastic material as material for the additive manufacturing of three-dimensional articles.

However, the material for additive manufacturing may be chosen from the group comprising composite materials, ceramic materials, metallic materials and concrete.

In a manner known per se and within the context of the present invention, the material is deposited in the form of overlapping or adjoining layers; the layers may be deposited in a variable number and with variable dimensions depending on the type of article to be manufactured.

The thermoplastic material for manufacturing the three-dimensional articles may be chosen from the group comprising acrylonitrile butadiene styrene (ABS), as such or reinforced with carbon fibre or glass fibre, nylon, as such or reinforced with carbon fibre or glass fibre, polycarbonates which may be reinforced with carbon fibre or glass fibre, polyether ether ketone (PEEK), polypropylene (PP), polyetherimide and polylactic acid (PLA).

The three-dimensional articles, not shown in the attached figures, may have different forms, dimensions and profiles and comprise portions or parts with geometric characteristics which are different from each other and predetermined.

The geometric characteristics of the portions of the articles may be chosen from the group comprising the form, the ramps, the radii of curvature, the widths and the thicknesses of the deposited layers of material, the overlapping of different or adjoining portions, or the interspaces between adjoining portions.

For example, the portions of the articles may be formed by curved sections with different radii of curvature, straight sections, portions with different thicknesses of the deposited layers of material, ramps with different inclinations, portions with different widths of the layers of deposited material and portions arranged side-by-side.

The method according to the present invention comprises preferably the following steps:
i) manufacturing test samples having forms, dimensions and geometric characteristics different from each other by means of deposition of a plurality of overlapping or adjoining layers of a material for additive manufacturing;
ii) detecting and collecting, at least during the step i) of manufacturing the test samples, data regarding process parameters relating to the deposition of the material and/or data regarding geometric and/or dimensional and/or qualitative and/or structural characteristics of the deposited layers of material;
iii) analysis and processing of the data detected during step ii) in order to derive and obtain optimized reference values of the process parameters, preferably for each of the test samples;
iv) manufacturing the three-dimensional article by means of deposition of a plurality of overlapping or adjoining layers of material for additive manufacturing based on the optimized reference values of the process parameters obtained for the test samples.

In the context of the present description, the optimized reference values of the process parameters are such that the parts or portions of the three-dimensional article manufactured using these optimized reference values are devoid or substantially devoid of deformations, geometric and/or dimensional variations with respect to the predetermined geometric characteristics and devoid of porosity and/or zones with reduced mechanical strength.

The geometric characteristics of the test samples made during step i) may be chosen within the group indicated above with reference to the portions of the three-dimensional articles. For each step i) involving manufacture of the test samples, instructions are defined for the adjustment of predetermined operating parameters regarding for example the extruder device and the movement means described below.

Moreover, for each step i) involving manufacture of the test samples, predefined environmental operating conditions are taken into account, these being correlated in particular to the nature of the material used for additive manufacturing or the conditions, such as the temperature and moisture, of the environment in which the production process is performed.

These operating instructions and conditions are associated with respective production processes, discussed further below with reference to the processing step iii) and to respective abstraction models obtained from the data detected during these production processes.

The data detection and collection step ii) is performed preferably by means of suitable automatic detection means 3 connected at least indirectly to the computerized numerical control system of the machine as explained in detail below.

The automatic detection means 3 may comprise, in addition to sensors of the known type, at least one telecamera and/or at least one heat camera and/or at least one three-dimensional scanner 33, at least one of the three of which is shown in schematically in FIG. 1.

The at least one telecamera and/or the at least one heat camera and/or the at least one three-dimensional scanner 33 are intended to detect the data regarding the geometric and/or dimensional and/or qualitative and/or structural characteristics of the deposited layers of material.

In particular, these latter characteristics detected by the at least one telecamera and/or by the at least one heat camera and/or by the at least one three-dimensional scanner 33 comprise, by way of example, the presence of imperfections, defects and geometric and dimensional variations in the deposited layers of material for additive manufacturing.

The formation and the presence of imperfections and defects in the deposited layers of material indicates the tendency to deformation of specific portions of the three-dimensional articles formed by means of deposition of layers of material, in particular thermoplastic material.

In accordance with this embodiment, the data obtained during the collection and detection step ii) also comprise the images and/or film recordings and/or the forms recorded by the at least one telecamera and by the at least one heat camera and/or by the at least one three-dimensional scanner 33.

Preferably, the data regarding the process parameters and the geometric and/or dimensional and/or qualitative and/or structural characteristics of the layers of material for additive manufacturing are detected in real time during the step i) for manufacturing the test samples. However, the data detection and collection step ii) may also be performed during the step iv) for manufacture of the three-dimensional article.

In this embodiment of method, the data detected and subsequently processed in order to obtain the optimized reference values of the process parameters is used to avoid the formation of imperfections and defects in the deposited layers of material during the subsequent manufacture of further three-dimensional articles.

Therefore the three-dimensional article obtained during the step iv) of the method according to the present invention may represent a test sample, the detected data of which is used subsequently in order to manufacture further three-dimensional articles using the optimized reference values of the process parameters obtained following processing.

Advantageously, the analysis and processing step iii) is performed by means of a process for training a software based on at least one artificial intelligence algorithm.

In particular, the at least one algorithm of the artificial intelligence software may be of the machining learning, deep learning and reinforcement learning type or also a combination of the three preceding types.

Said analysis and processing step iii) performed by means of training of the artificial intelligence software may also be defined as a calibration or learning step.

Consequently, the method according to the present invention may also be defined as a predictive method for manufacturing three-dimensional articles based on artificial intelligence. The data detected and collected during step ii), as well as the environmental operating conditions, represent an input for the training process of the at least one artificial intelligence algorithm; the optimized reference values of the process parameters represent an output of the training process of the at least one artificial intelligence algorithm.

Moreover, the detection and the collection of the data during step ii) and the processing thereof during step iii) in order to obtain the optimized reference values of the process parameters may be defined as being a predictive virtual model for the following step iv) involving manufacture of the three-dimensional article.

The predictive virtual model represents a digital twin of the abstraction model obtained from the data detected during the various physical processes for production of the three-dimensional articles.

Said predictive virtual model uses advantageously artificial neural network models, such as Recurrent Neural Networks (RNNs) or Long Short-Term Memory (LSTM), regression models or SVM (Support Vector Machine) models.

In this way, the predictive virtual model allows the use also of historical series of data of the process parameters detected during step ii) of the method or geometric and/or dimensional and/or qualitative and/or structural characteristics of the layers of material for additive manufacturing, so as to provide predefined outputs of the optimized reference values for events which take place or will take place at predetermined time intervals during the process for production of the three-dimensional articles.

Therefore, differently from the known solutions in the sector, the present invention uses models known in the sector of artificial intelligence for adjusting in a predictive manner the process parameters depending on the operating and production conditions and the environmental conditions, thereby overcoming the limitations of feedback adjustment.

FIG. 4 shows in schematic form a multi-level deep neural network model which may be used in the present invention.

The left-hand arrow, forming part of the first level, represents the inputs P for the processing, formed by the detected data of the process parameters, while the nodes α_{(1, 2, 3, 4, n-1, n)}, β_{(1, 2, 3, 4, n-1, n)}, γ_{(1, 2, 3, 4, n-1, n)} and δ_{(1, 2, 3, 4, n-1, n)} represent the various process parameters at the various processing levels.

At the end of the processing process (last level on the right of the model), optimized reference values which represent the outputs R of the training process are obtained.

The environmental conditions may also be used in the processing process by the deep neural network, in combination with the data detected for the production processes.

The process parameters to be processed α, β, γ and δ may be chosen from among those indicated above and the number of them may be different, as schematically indicated by means of the broken lines in FIG. 4.

The steps i), ii) and iii) may be repeated a predefined number of times so as to store the data and train the at least one artificial intelligence algorithm to process and improve the optimized reference values of the process parameters in a continuous manner.

In particular, the steps i)-iii) may be repeated for as long as the layers of material, in particular thermoplastic material, of the test samples or of the three-dimensional articles are devoid or substantially devoid of deformations and/or imperfections and/or geometric and dimensional variations.

For this purpose, the data detected by the automatic detection means 3 during step ii) may be stored in a database during a storage step, each test sample being correlated to a corresponding series of data.

The data is stored with a proprietary format and allows the execution of continuous training of the artificial intelligence software, namely also after the step i) and step ii) of the method have been completed and also during the subsequent manufacture of further three-dimensional articles.

The method may also comprise a step involving analysis of the three-dimensional article to be manufactured and decomposition of the geometry of the three-dimensional article into one or more portions, this step being performed preferably upstream of step iv).

This step of analysis and decomposition of the three-dimensional article may be performed using 3D CAD software, namely a solid modelling software; on the basis of this analysis it is possible to obtain, by means of CAM software, the instruction regarding the operations to be performed, for example the trajectories of the nozzle of the extruder device, during the step iv) of manufacture of the three-dimensional article.

Said CAD and/or CAM software may also be interfaced with the artificial intelligence software used in step iii); in this way this software is trained in order to optimize the procedures for analysis and decomposition of the article and for obtaining the instructions for the manufacture of the article.

Suitably, the test samples which were made during step i) and the data of which are used to obtain the optimized reference values have forms, dimensions and geometric characteristics corresponding to the form, dimensions and geometric characteristics of the portions obtained from the decomposition of the geometry of the three-dimensional article before manufacture thereof.

Alternatively, during the step iv) for manufacture of the three-dimensional article, it is also possible to use the optimized reference values extrapolated from the data detected for test samples having a form, dimensions and geometric characteristics different from the form, the dimensions and the geometric characteristics of the portions of the article to be manufactured.

Therefore, it is also possible to use different combinations of the data obtained from the test samples manufactured during the step i) in order to manufacture the three-dimensional article during the step iv).

The step iv) of manufacturing the three-dimensional article is performed by means of at least one extruder device 6 mounted on a numerical control machine 5 with Cartesian or anthropomorphic movements. These movements are obtained by means 10 for the movement of the at least one extruder device 6.

With reference to the attached figures the numerical control machine 5 and the extruder device 6 are shown in the detail of FIG. 2 and FIG. 3, respectively.

The machine 5 with the at least one extruder device 6 and the movement means 10 are described in detail below with reference to the plant 1.

Furthermore, the machine 5 is provided with a computerized numerical control system or CNC 11 having dedicated software installed inside it for controlling the at least one extruder device 6 and the movement means 10.

The automatic detection means 3 are also connected at least indirectly to the computerized numerical control system 11 of the machine 5, as explained further below with reference to the plant 1.

The instructions regarding the operations and the displacement trajectories of the at least one extruder device 6 obtained by means of the CAM software as indicated above are loaded into the computerized numerical control system 11 of the machine 5.

The at least one extruder device 6 intended for the deposition of overlapping or adjoining layers of thermoplastic material comprises at least one screw extruder element 14, a pump 16 and a nozzle 18 of the type described above with reference to the prior art.

These components are shown in schematic form in FIG. 1 and partially in FIG. 3 and will not be described further in the present description since known according to the state of the art.

The software based on the at least one artificial intelligence algorithm is designed to adjust and implement the dedicated software of the computerized numerical control system 11 based on the optimized reference values of the process parameters, which may therefore be used as information and instructions relating to the operating parameters of the extruder device and the movement means.

In particular, during step iv), the software based on the at least one artificial intelligence algorithm, trained on the basis of the data detected during step ii), implements the software of the numerical control machine 5 which consequently adjusts operation of the extruder device 6, of the movement means 10 and of the automatic detection device 3 during the manufacture of the three-dimensional article.

In this way, the various portions of each three-dimensional article are made continuously, while avoiding at the same time the formation of imperfections, defects or geometric and dimensional variations in the layers.

The process parameters preferably comprise the temperature or the temperatures of the thermoplastic material before extrusion by the extruder device 6, the temperature of the thermoplastic material deposited in overlapping or adjoining layers, the flowrate of the thermoplastic material through the nozzle 18 and the pressure of the thermoplastic material upstream and/or downstream of the pump 16.

In order to detect the data associated with the aforementioned process parameters, the automatic detection means 3 may comprise temperature sensors, flowrate measuring devices, pressure gauges, proximity sensors and the heat camera 33 indicated above.

The process parameters may also comprise the speed of displacement of the at least one extruder device 6, the inclination of the nozzle 18 with respect to the table 12 supporting the articles, the distance of the nozzle 18 from the support table 12 or from a surface of the three-dimensional article, the speed of rotation of the pump 16 and the speed of rotation of the screw of the extruder 14.

These latter parameters may also be defined as operating parameters of the at least one extruder device 6 and of the movement means 10; the listing of these process parameters in the present text is provided only by way of a non-limiting example of the scope of protection of the invention.

In the embodiment which envisages the deposition of overlapping or adjoining layers of material for additive manufacturing, different from the thermoplastic material of the type indicated above, the extruder device 6 may be suitably modified or replaced by another device for this purpose.

As already mentioned, the present invention also relates to a plant 1—shown schematically in FIG. 1—which comprises the machine 5 for the deposition of the plurality of overlapping layers of material for the additive manufacturing described above and a processing unit 4, in particular a high-performance processing and calculation unit, having an installed software.

As shown in FIG. 1, the machine 5 has, associated with it, the processing unit 4 which may be situated outside the machine 5 and connected thereto by means of a connection 8, preferably a connection with Ethernet protocol or by means of another type of equivalent connection. Alternatively, the processing unit 4 may be integrated in the machine 5.

Advantageously, the software of the processing unit 4 is based on at least one artificial intelligence and self-learning/automatic learning algorithm.

Therefore, the artificial intelligence software of the processing unit 4 allows the data analysis and processing step iii) described above with reference to the method to be carried out.

In particular, the artificial intelligence software may operate on the basis of the processes and the models described above with reference to the method.

The processing unit 4 may be formed by a controller integrated in the machine 5 and by a high-performance calculation unit situated outside the machine 5 and connected to the controller. Alternatively, the high-performance calculation unit may also be integrated in the machine 5.

Advantageously, a first module of the software based on the at least one artificial intelligence algorithm is installed in the controller and a second module of the software based on the at least one artificial intelligence algorithm is installed in the high-performance calculation unit.

Furthermore the machine 5 comprises:
the at least one extruder device 6 for depositing the overlapping or adjoining layers of material for additive manufacturing, in particular thermoplastic material;
the means 10 for movement of the at least one extruder device 6;
the table 12 for supporting the three-dimensional article on which the layers of material are deposited;
the means 3 for automatic detection of the data regarding the process parameters relating to the deposition of the layers of material and/or the data regarding the geometric and/or dimensional and/or qualitative and/or structural characteristics of the deposited layers of material;
the computerized numerical control system or CNC 11, associated with a PLC 13 and comprising the dedicated software for controlling the at least one extruder device 6 and the movement means 10.

The at least one extruder device 6 and the movement means 10 are shown in schematic form in FIG. 1 and in detail in FIGS. 2 and 3; the support table 12 is shown in detail in FIG. 2; the CNC 11 and the PLC 13 are shown in schematic form in FIG. 1.

The CNC 11 and the PLC 13 form a control unit 27 for managing the machine 5.

In the detailed illustration of FIG. 2, the machine 5 for depositing the layers of thermoplastic material comprises an extruder device 6 movable by means of the movement means 10 and also a second movable working unit 31 provided with a spindle and intended to carry out machining operations on the three-dimensional article obtained by means of deposition of the layers of material for additive manufacturing by means of stock removal obtained using milling cutter tools mounted on the spindle.

As indicated above, the at least one extruder device 6 configured for deposition of the layers of thermoplastic material comprises at least one screw extruder element 14, a pump 16 and a nozzle 18.

The thermoplastic material is fed to the at least one extruder device 6 by means of feeder means 21 of the known type which may be provided on the extruder device 6 and on the machine 5 on the outside of the support table 12, as shown in FIGS. 2 and 3.

Advantageously, the machine 5 comprises servo motors 15 and 17 of the extruder element 14 and pump 16, respectively 16; these servo motors 15, 17 are shown in schematic form in FIG. 1.

Furthermore, the servo motors 15, 17 of the extruder element 14 and of the pump 16 are connected at least indirectly to the CNC 11 of the machine 5 for controlled activation thereof.

In this respect, the machine 5 may comprise a local control unit 19 which is connected to the at least one extruder device 6, to the automatic detection means 3 and/or to the movement means 10.

Furthermore, the local control unit 19 is connected to the CNC 11 by means of a dedicated connection 7 and to the servo motors 15, 17 for controlling activation thereof, as shown in FIG. 1.

Furthermore, in the embodiment shown in FIG. 1, it can be seen that the local control unit 19 provides closed-loop feedback control with the automatic detection means 3 and the servo motors 15, 17 to which it is connected.

As shown schematically in FIG. 1, the high-performance processing unit 4, in particular the controller, is connected to the local control unit 19 by means of the connection 8 and to the CNC by means of the dedicated connection 9, also preferably with an Ethernet protocol.

The movement means 10 may be of the anthropomorphic type, namely comprise a robotic arm.

Alternatively, as shown in FIG. 2, the movement means 10 are of the Cartesian type, namely of the type comprising, for example, a carriage 20 slidably mounted on a beam 20 which is also slidably mounted on a pair of side shoulders 24.

The at least one extruder device 6 is movable within the spaced situated above the support table 12 by means of the movement means 10 so that it can be positioned at any point thereon.

Furthermore, the movement means 10 are configured to move the at least one extruder device 6 along a direction perpendicular to the support table, so as to adjust the distance of the nozzle 18 from the support table 12.

As shown more clearly in FIG. 3, the movement means 10 may comprise slides 26 for the movement of the extruder device 6 along the direction perpendicular to the carriage 20.

The machining unit 31 may also be mounted on a respective carriage 20 slidably mounted on a respective beam 22, as shown in FIG. 2.

The automatic detection means 3, as shown schematically in FIG. 1, may be associated with the extruder device 6 and/or with the movement means 10 in order to detect the data regarding the process parameters relating to the deposition of the layers of material.

The process parameters are those indicated above with reference to step ii) of the method. As already mentioned, the automatic detection means 3 may comprise at least one telecamera and/or at least one heat camera and/or at least one three-dimensional scanner 33 designed to detect the data regarding the geometric and/or dimensional and/or qualitative and/or structural characteristics of the layers of material deposited for additive manufacturing, namely the presence of imperfections and defects in the deposited layers of material or the presence of geometric and dimensional variations with respect to the predetermined geometric characteristics.

The high-performance processing unit 4 with the software based on the at least one artificial intelligence algorithm is configured to receive the data from the automatic detection means 3, preferably by means of the local control unit 19, to process said data and to obtain the optimized reference values of the process parameters from said data.

As already mentioned, the optimized reference values of the process parameters are such that the three-dimensional articles which can be obtained using these optimized reference values are devoid or more or less devoid of defects such as geometrical and/or dimensional variations with respect to the predetermined geometrical characteristics, deformations, delamination, porosity and/or zones with reduced mechanical strength or other similar imperfections affecting the deposited layers of material, in particular thermoplastic material. The plant 1 may also comprise a database, not shown in the figures, associated with the processing unit 4, in particular with the high-performance calculation unit, and configured to store the data detected by the automatic detection means 3 before processing by the processing unit 4.

The artificial intelligence software formed by the two modules as described above and installed in the high-performance processing unit 4 is configured to implement the software of the computerized numerical control system 11 of the machine 5 on the basis of the optimized reference values of the process parameters.

In particular, the second module of the software installed in the high-performance processing and calculation unit is able to process a considerable amount of data detected during the step ii) and send it to the controller for adjustment and implementation of the computerized numerical control system 11 of the machine 5.

Furthermore, the software of the processing unit 4, by means of repetition of the step iii) for processing the new data which it continues to receive from the automatic detection means 3, continues to be trained so that the reference values which can be obtained at the end of processing are increasingly improved.

Therefore, the data detected by the automatic detection means 3 form an input for training the software of the processing unit 4 and the optimized reference values of the process parameters represent an output of the training process.

The software of the computerized numerical control system 11, suitably implemented and adjusted on the basis of the optimized reference values of the process parameters, may process both the information and instructions for adjustment of the process parameters of the extruder device 6 and the information and instructions regarding the trajectories followed by the extruder device 6 via the movement means 10.

In a manner known per se, said information and instructions may be contained in a file which has been previously obtained by means of CAM software from a model of the article obtained by means of 3D or solid modelling CAD software designed to be loaded in the computerized numerical control system 11 of the machine 5.

Consequently, the manufacture of the three-dimensional articles by the plant 11 is performed based on data collected beforehand and processed by means of training of the software based on the at least one artificial intelligence algorithm.

It may be mentioned that the steps i) and iv) of the method according to the present invention may also be performed using two separate plants, provided that both of them comprise all the components described above.

From the above description it is now clear how the method and the plant for manufacturing three-dimensional articles according to the present invention are able to achieve advantageously the predefined objects.

In particular, by means of training of the software based on the at least one artificial intelligence algorithm and the subsequent adjustment and implementation of the software of the computerized numerical control system based on the optimized reference values of the process parameters, the deposition of the plurality of overlapping or adjoining layers of material for additive manufacturing may be performed avoiding the formation of imperfections such as geometrical or dimensional variations with respect to the predetermined geometric characteristics, deformations or delamination.

Moreover, with the CNC software it is possible to control the extruder device and/or the movement means of the numerical control machine so that the deposition of the layers is performed in a particularly rapid manner and with limited wastage of material.

Obviously, the above description of embodiments applying the innovative principles of the present invention is provided by way of example of these innovative principles and must therefore not be regarded as limiting the scope of the rights claimed herein.

1. A method for manufacturing three-dimensional articles by deposition of a plurality of overlapping or adjoining layers of a material for additive manufacturing, comprising the following steps:
(i) manufacturing test samples having forms, dimensions and geometric characteristics different from each other by means of deposition of a plurality of overlapping or adjoining layers of material;
(ii) detecting and collecting, at least during said step (i) of manufacturing the test samples, data regarding process parameters relating to one or more of the deposition of the material and data regarding one or more of geometric and dimensional and qualitative and structural characteristics of the deposited layers of material;
(iii) analysis and processing of the data detected during step (ii) in order to derive and obtain optimized reference values of the process parameters;
(iv) manufacturing the three-dimensional article by means of deposition of a plurality of overlapping or adjoining layers of material for additive manufacturing based on the optimized reference values of the process parameters;
wherein said data analysis and processing step (iii) is performed by means of a process for training a software based on at least one artificial intelligence algorithm.

2. The method according to claim 1, characterized in that said detection and collection step ii) is performed by means of automatic detection means.

3. The method according to claim 2, characterized in that said automatic detection means comprise one or more of at least one telecamera and at least one heat camera and at least one three-dimensional scanner designed to detect the data regarding the one or more of geometric and dimensional and qualitative and structural characteristics of the deposited layers of material, said data comprising one or more of images and film recordings and forms recorded by said one or more of at least one telecamera and by said at least one heat camera and by said at least one three-dimensional scanner.

4. The method according to claim 1, further comprising a step for analysis of the three-dimensional article to be manufactured and decomposition of the geometry of the three-dimensional article into one or more portions performed upstream of step (iv).

5. The method according to claim 4, characterized in that the test samples have forms, dimensions and geometric characteristics corresponding to the forms, dimensions and geometric characteristics of the portions of the article to be to be manufactured.

6. The method according to claim 4, characterized in that the step for analysis and decomposition of the three-dimensional article is performed using 3D CAD software or solid modelling so as to obtain instructions regarding the operations to be performed by means of CAM software for manufacture of the three-dimensional article, the CAM and CAD software being interfaced with the software based on at least one artificial intelligence algorithm so as to be trained in such a way as to optimize the procedures for analysis and decomposition of the article and for obtaining instructions for the manufacture of the article.

7. The method according to claim 1, characterized in that the material for additive manufacturing is chosen from the group comprising thermoplastic materials, composite materials, ceramic materials, metallic materials and concrete.

8. The method according to claim 5, characterized in that the geometric characteristics of said test samples and of said portions of the three-dimensional article comprise the radii of curvature, the widths and the thicknesses of the deposited layers of material, the overlapping of different or adjoining portions, and the interspaces between adjoining portions.

9. The method according to claim 7, characterized in that said step (iv) for manufacturing the three-dimensional article by means of deposition of the layers of thermoplastic material is performed by means of at least one extruder device for extruding the thermoplastic material comprising at least one screw extruder element, a pump and a nozzle.

10. The method according to claim 9, characterized in that said at least one extruder device is mounted on a machine with Cartesian or anthropomorphic movements which has a computerized numerical control system with dedicated software for the control of the at least one extruder device and the movement means of the at least one extruder device, said dedicated software being adjusted and implemented on the basis of said optimized reference values of the process parameters.

11. The method according to claim 10, characterized in that the software based on the at least one artificial intelligence algorithm, trained on the basis of the data detected during step (ii), is configured to implement the dedicated software of the numerical control machine which consequently adjusts operation of the extruder device, of the movement means and of the automatic detection device during the manufacture of the three-dimensional article.

12. The method according to claim 7, characterized in that the process parameters detected in said step (ii) comprise the temperature of the thermoplastic material, the flowrate of the thermoplastic material, and the pressure of the thermoplastic material upstream and/or downstream of the pump.

13. The method according to claim 9, characterized in that the process parameters detected in said step (ii) comprise the speed of displacement of the at least one extruder device, the inclination of the nozzle, the distance of the nozzle from a table supporting the three-dimensional article or from a surface of the three-dimensional article, the speed of rotation of the pump and the speed of rotation of the screw of the extruder.

14. The method according to claim 3, characterized in that the one or more geometric and dimensional and qualitative and structural characteristics of the layers of material for additive manufacturing detected in said step (ii) comprise the presence of imperfections or defects in the deposited layers of material.

15. The method according to claim 1, characterized in that said data detection and collection step (ii) is performed during said step (iv) for manufacturing the three-dimensional article, the three-dimensional article manufactured in said step (iv) being a test sample for the subsequent manufacture of three-dimensional articles.

16. The method according to claim 1, characterized in that said steps (i)-(iii) are repeated a predefined number of times so as to store said data and train said at least one artificial intelligence algorithm to process and improve the optimized reference values of the process parameters.

17. The method according to claim 1, characterized in that the at least one algorithm of the artificial intelligence software is of the machine learning, deep learning and reinforcement learning type or a combination of these three types.

18. The method according to claim 1, characterized in that the data detected and collected in said step (ii) forms an input for the process of training the at least one artificial intelligence algorithm and the optimized reference values of the process parameters form an output of the process for training of the at least one artificial intelligence algorithm.

19. A plant for manufacturing three-dimensional articles by deposition of a plurality of overlapping or adjoining layers of a material for additive manufacturing, said plant comprising:
a processing unit having an installed software;
a machine for deposition of the layers of material for additive manufacturing comprising:
at least one extruder device for the deposition of the layers of material;
means for the movement of the at least one extruder device;
a table for supporting the three-dimensional articles;
means for the automatic detection of data regarding the process parameters relating to one or more of the deposition of the layers of material and data regarding the geometric and/or dimensional and qualitative and structural characteristics of the deposited layers of material for additive manufacturing;
a computerized numerical control system having dedicated software for controlling said at least one extruder device and said movement means;
said processing unit being configured to receive the data from said automatic detection means, to process said data and to obtain optimized reference values of the process parameters from said data;
wherein the software of said processing unit is based on at least one artificial intelligence algorithm and is configured to adjust and implement the software of the computerized numerical control system.

20. The plant according to claim 19, characterized in that the automatic detection means comprise one or more of at least one telecamera and at least one heat camera and at least one three-dimensional scanner.

21. The plant (1) according to claim 19, characterized in that said machine comprises a local control unit connected to said at least one extruder device and one or more of said automatic detection means and said movement means, said local control unit being connected to said processing unit.

22. The plant according to claim 19, characterized in that the information and the instructions for the computerized numerical control system are contained in a file obtained by means CAM software based on a model of the article obtained by means of 3D or solid modelling CAD software, the CAD and CAM software being interfaced with said software based on at least one artificial intelligence algorithm so as to be trained in such a way as to optimize the procedures for analysis and decomposition of the article and for obtaining instructions for the manufacture of the article.

23. The plant according to claim 19, characterized in that the at least one algorithm of the artificial intelligence software is of the machine learning, deep learning and reinforcement learning type or also a combination of these three types.

24. The method according to claim 9, characterized in that the process parameters detected in said step (ii) comprise the temperature of the thermoplastic material, the flowrate of the thermoplastic material, and the pressure of the thermoplastic material upstream and/or downstream of the pump.
